(19) United States
(12) Patent Application Publication
(10) Pub. No.: US 2010/0246071 A1
(43) Pub. Date: Sep. 30, 2010

(54) HEAD SUSPENSION ASSEMBLY AND MAGNETIC DISK DRIVE

(75) Inventors: Yusuke NOJIMA, Ome-shi (JP); Shinji KOGANEZAWA, Atsugi-shi (JP)

Correspondence Address: KNOBBE MARTENS OLSON & BEAR LLP, 2040 MAIN STREET, FOURTEENTH FLOOR, IRVINE, CA, 92614, US

(73) Assignee: Toshiba Storage Device Corporation, Tokyo (JP)

(21) Appl. No.: 12/751,871

(22) Filed: Mar. 31, 2010

(30) Foreign Application Priority Data
Mar. 31, 2009 (JP) 2009-084867

(51) Int. Cl. G11B 21/24

(52) U.S. Cl. 360/294.4; G9B/21.028

(57) ABSTRACT

According to one embodiment, a head suspension assembly includes a load beam supporting a head, and a microactuator configured to swing the load beam. The microactuator includes two piezoelectric elements configured to undergo shear deformation when supplied with a voltage and juxtaposed in such a manner that respective shear deformations thereof are opposite in direction, a first electrode and a second electrode arranged so as to hold the piezoelectric elements therebetween, and a support plate joined to the first electrode with an insulating layer therebetween and joined to the load beam to support the load beam.

### CROSS-REFERENCE TO RELATED APPLICATIONS

This application is based upon and claims the benefit of priority from Japanese Patent Application No. 2009-084867, filed Mar. 31, 2009, the entire contents of which are incorporated herein by reference.

### BACKGROUND

1. Field

One embodiment of the invention relates to a head suspension assembly and a magnetic disk drive provided with the same.

2. Description of the Related Art

The capacity of a magnetic disk drive is enlarged by increasing the density of recording tracks of a magnetic disk used therein. In order to accurately read and write data to and from densely packed recording tracks, it is necessary to improve the accuracy of head positioning transversely relative to the tracks. This improvement in positioning accuracy requires the development of microactuators for high-speed, high-accuracy head positioning.

As one such microactuator, a head suspension assembly that uses shear deformations of piezoelectric elements is proposed in, for example, Jpn. Pat. Appln. KOKAI Publication No. 2005-312200. This suspension assembly comprises a baseplate, a load beam, and a pair of piezoelectric elements. The baseplate is fixed to a carriage arm of a magnetic disk drive. The load beam supports a head. The piezoelectric elements connect the baseplate and load beam. One surface of each of the piezoelectric elements is joined to a conductive fixed electrode and also joined to the baseplate through an insulating layer. The other surface of each piezoelectric element is joined to a conductive movable electrode and also joined to a movable member through an insulating layer. The load beam is joined to the movable member, thereby forming a head suspension as a whole.

The piezoelectric elements are oppositely polarized and arranged side by side. If a predetermined voltage is applied to the fixed and movable electrodes, the movable electrode is independently displaced in its shear direction with respect to the fixed electrode. Thereupon, these piezoelectric elements convert displacements attributable to their shear deformations into a swinging motion of the head suspension through the movable member. This swinging motion enables the head to be displaced transversely relative to the recording tracks of the magnetic disk.

Since the load beam is slightly moved in its swinging direction with respect to the baseplate, in the head suspension thus positioned by the carriage arm, the head mounted on its distal end can be positioned transversely relative to the recording tracks with high accuracy at high speed.

Jpn. Pat. Appln. KOKAI Publication No. 2004-220701 discloses a structure of one such head suspension assembly in which a suspension flexure is accurately affixed to a spring element of a head suspension.

According to this head suspension assembly, the suspension flexure and the spring element of the head suspension affixed to the flexure are provided with a projection and hole portion, respectively, corresponding to each other. During the manufacture of the head suspension assembly, the suspension flexure and the spring element of the head suspension are positioned by means of the projection and hole as they are laminated to each other. By doing this, the suspension flexure can be accurately affixed to the spring element.

In the head suspension assembly described above, however, a laminated portion including piezoelectric elements comprises a baseplate, insulating layer, fixed electrode, piezoelectric elements, movable electrode, insulating layer, movable member, and load beam. Thus, due to the high number of components and assembly man-hours for the laminated portion, a problem of high manufacturing cost results.

### BRIEF DESCRIPTION OF THE SEVERAL VIEWS OF THE DRAWINGS

A general architecture that implements the various features of the invention will now be described with reference to the drawings. The drawings and the associated descriptions are provided to illustrate embodiments of the invention and not to limit the scope of the invention.

FIG. 1 is an exemplary perspective view showing a head suspension assembly of a magnetic disk drive according to one embodiment of the invention;

FIG. 2A is an exemplary plan view showing a microactuator and its surroundings of a head suspension in the head suspension assembly;

FIG. 2B is an exemplary side view showing the microactuator and its surroundings of the head suspension;

FIG. 3 is an exemplary exploded perspective view of the microactuator and its surroundings of the head suspension, taken obliquely from above;

FIG. 4 is an exemplary exploded perspective view of the microactuator and its surroundings of the head suspension, taken obliquely from below;

FIG. 5A is an exemplary plan view showing a support plate of the microactuator;

FIG. 5B is an exemplary rear view showing the support plate of the microactuator;

FIG. 6A is an exemplary enlarged plan view showing a part of the support plate;

FIG. 6B is an exemplary enlarged side view showing a part of the support plate; and

FIG. 7 is an exemplary plan view showing the magnetic disk drive.

### DETAILED DESCRIPTION

Various embodiments according to the invention will be described hereinafter with reference to the accompanying drawings. In general, according to an aspect of the invention, there is provided a head suspension assembly comprising: a load beam supporting a head; and a microactuator configured to swing the load beam, the microactuator comprising two piezoelectric elements configured to undergo shear deformation when supplied with a voltage and juxtaposed in such a manner that respective shear deformations thereof are opposite in direction, a first electrode and a second electrode arranged so as to hold the piezoelectric elements therebetween, and a support plate joined to the first electrode with an insulating layer therebetween and joined to the load beam to support the load beam.

According to another aspect of the invention, there is provided a magnetic disk drive comprising: a head configured to process information for a disk recording medium; and a rotatable head suspension assembly supporting the head, the head suspension assembly comprising a load beam supporting the head and a microactuator configured to swing the load beam. The microactuator comprises two piezoelectric elements configured to undergo shear deformation when supplied with a voltage and juxtaposed in such a manner that respective shear deformations thereof are opposite in direction, a first electrode and a second electrode arranged so as to hold the piezoelectric elements therebetween, and a support plate joined to the first electrode with an insulating layer therebetween and joined to the load beam to support the load beam.

A magnetic disk drive according to one embodiment of the invention will now be described in detail with reference to the accompanying drawings.

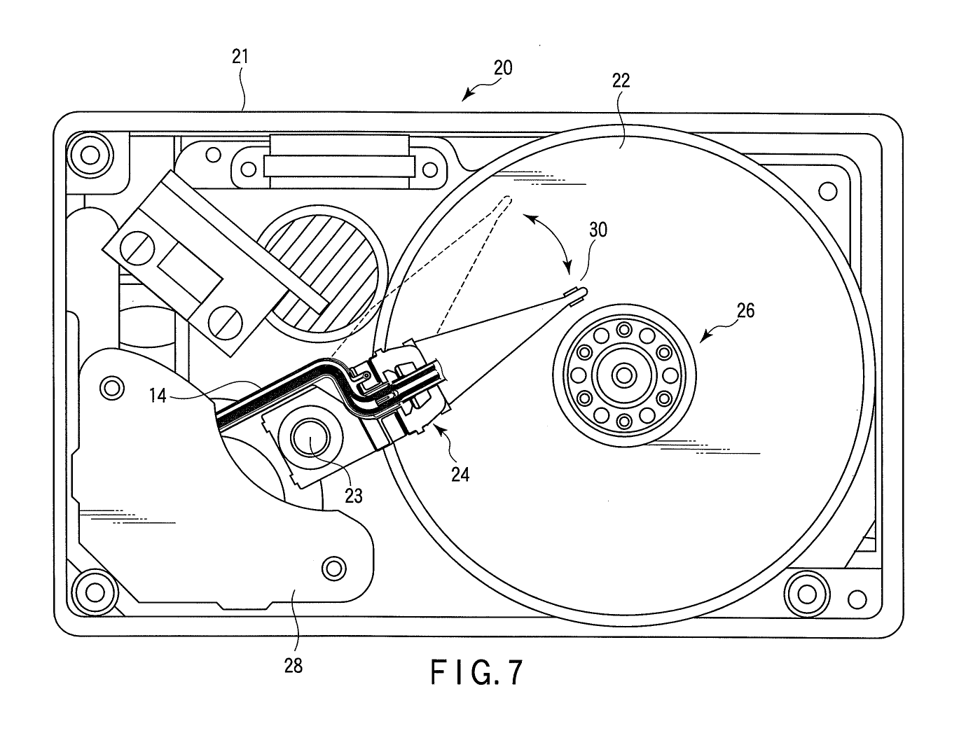

FIG. 7 shows an example of an internal configuration of the magnetic disk drive comprising a head suspension assembly. A magnetic disk drive 20 comprises a disk enclosure 21. The disk enclosure 21 contains therein a magnetic disk 22 for use as a recording medium, a spindle motor 26, a head suspension assembly 24, and an actuator, such as a voice coil motor (VCM) 28. The spindle motor 26 is configured to support and rotate the magnetic disk 22. The head suspension assembly 24 is rotatable around a shaft 23. The VCM 28 rotates and positions the head suspension assembly 24. A magnetic head 30 (mentioned later) mounted on the distal end of the head suspension assembly 24 scans the magnetic disk 22 from above, thereby writing and reading data to and from the disk 22.

A main board (not shown) is arranged on the reverse side of the disk enclosure 21. The main board is mounted with a modem circuit, control circuit, etc. The modem circuit modulates signals recorded in the magnetic disk 22 and demodulates read signals. The control circuit controls the rotation of the disk 22 and the pivoting of the head suspension assembly 24. The main board and the magnetic head 30 in the disk enclosure 21 are electrically connected to each other by a suspension flexure 14. Record and reproduce signals are transmitted through the flexure 14.

The head suspension assembly 24 comprises a microactuator, which will be described later. When the suspension assembly 24 is controlled in rotation so that the magnetic head 30 is positioned corresponding to a desired recording track of the magnetic disk 22, the magnetic head 30 can be positioned more quickly and accurately with respect to the recording track by being swung by the microactuator.

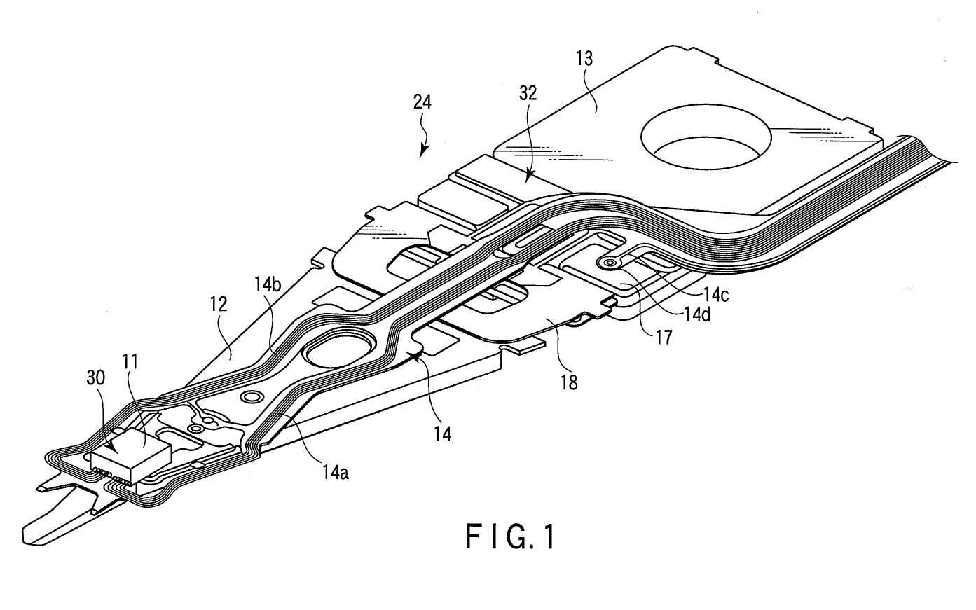

The following is a detailed description of the head suspension assembly 24. FIG. 1 shows an outline of the suspension assembly 24. As shown in FIG. 1, the suspension assembly 24 comprises a head suspension, which comprises a load beam 12, baseplate 13, and microactuator 32. The load beam 12 carries a head slider 11 of the magnetic head 30 on its distal end side. The baseplate 13 is disposed on the proximal end side of the load beam 12. The microactuator 32 connects the load beam 12 and baseplate 13. The head suspension assembly 24 further comprises the suspension flexure 14 that is electrically connected to the magnetic head 30 and microactuator 32.

The magnetic head 30 comprises the head slider 11 and a very small head element, which is mechanically supported on the slider 11 and serves to read and write data. The suspension flexure 14 is electrically connected to the head element. The baseplate 13 is fixed to a carriage arm and supports the head suspension assembly 24 for rotating around the shaft 23.

As shown in FIGS. 1, 2A, 2B, 3 and 4, the microactuator 32 between the load beam 12 and baseplate 13 comprises two piezoelectric elements 15 and 16, hinge plate (first electrode) 17, and support plate 18 to which the load beam 12 is fixed. All these elements are laminated on the baseplate 13. The baseplate 13 is formed of an electrically conductive plate of, for example, stainless steel and comprises a flat portion 13a on one end thereof. The flat portion 13a constitutes a fixed electrode (second electrode). The piezoelectric elements 15 and 16 are joined to the flat portion 13a by, for example, an electrically conductive adhesive. Thus, the baseplate 13 serves as one (fixed or second electrode) of the electrodes that supply electricity to the piezoelectric elements 15 and 16.

Each of the piezoelectric elements 15 and 16 is in the form of a rectangular plate, for example, and undergoes shear deformation when supplied with a voltage. The elements 15 and 16 are joined to the baseplate 13 in such a manner that their respective shear deformations are opposite in direction. In this embodiment, the baseplate 13 is used as a fixed electrode so that the number of fixed electrode members is reduced. If necessary, however, an independent fixed electrode may be interposed between the baseplate 13 and piezoelectric elements 15 and 16.

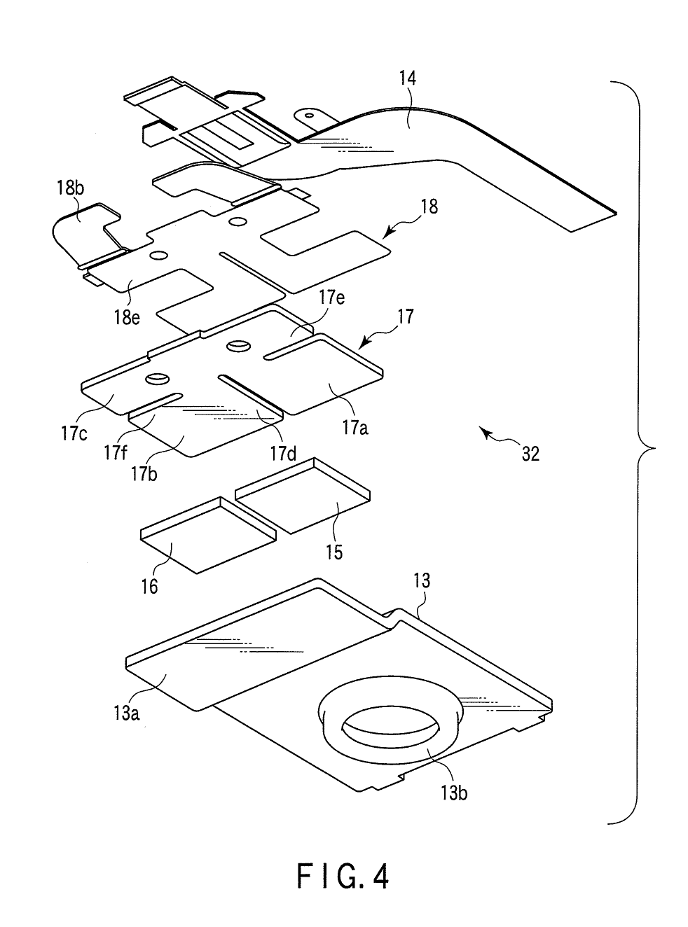

The hinge plate 17 is joined to the respective upper surfaces of the piezoelectric elements 15 and 16. The hinge plate 17 is formed of an electrically conductive plate of, for example, stainless steel and constitutes a movable electrode (first electrode). As seen from FIG. 4, the hinge plate 17 is rectangular and comprises a joint surface 17a to which the piezoelectric element 15 is joined, joint surface 17b to which the piezoelectric element 16 is joined, and non-joint surface 17c to which neither of the piezoelectric elements 15 and 16 is joined. The hinge plate 17 comprises slits 17d to 17f that partially divide the joint surfaces 17a and 17b and non-joint surface 17c from one another, thereby preventing interference between the respective shear deformations of the magnetic disks 16 with respect to the baseplate 13.

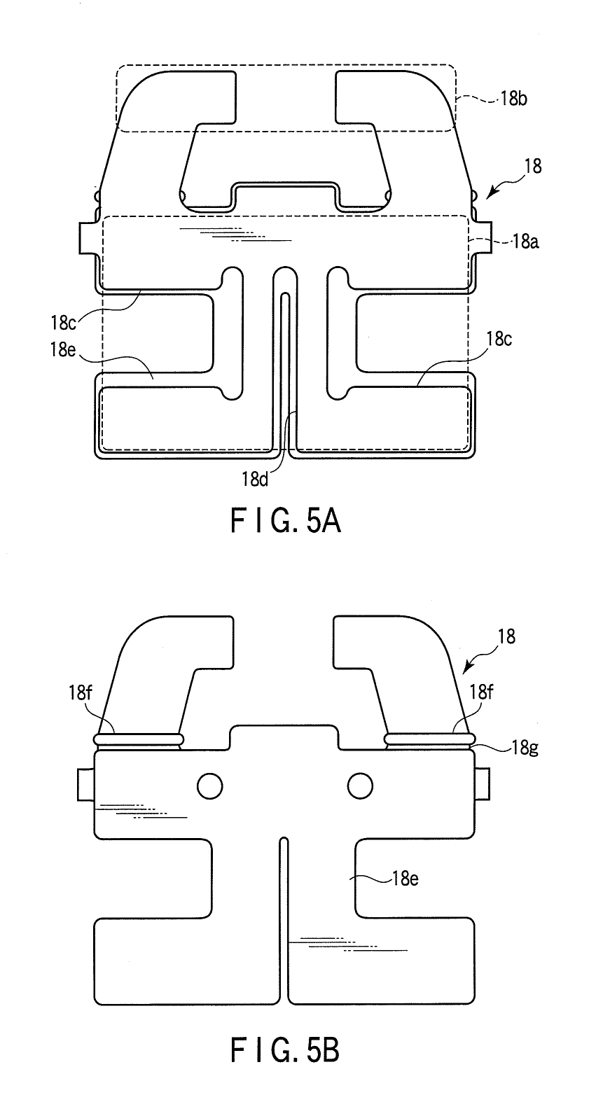

The support plate 18 is joined to the upper surface of the hinge plate 17. The support plate 18 is formed of an electrically conductive spring member of, for example, stainless steel and constitutes a part that supports the load beam 12 on the hinge plate 17 as a movable member. As shown in FIG. 5A, the support plate 18 comprises a hinge plate junction (electrode junction) 18a and load beam junction 18b extending from the junction 18a. The hinge plate junction 18a is joined to the hinge plate 17 so as to cover it entirely. The load beam 12 is joined to the load beam junction 18b. The hinge plate junction 18a of the support plate 18 comprises a pair of notches 18c and a slit 18d. The hinge plate 17 is partially exposed through the notches 18c. The slit 18d is located corresponding to the central slit 17d of the hinge plate 17. The suspension flexure 14 is electrically connected directly to the hinge plate 17 with ease through the notches 18c. The slit 18d serves to prevent the action of the hinge plate 17 from being hindered by the shear deformations of the piezoelectric elements 15 and 16. The notches 18c may be replaced with openings through which the hinge plate 17 can be partially exposed.

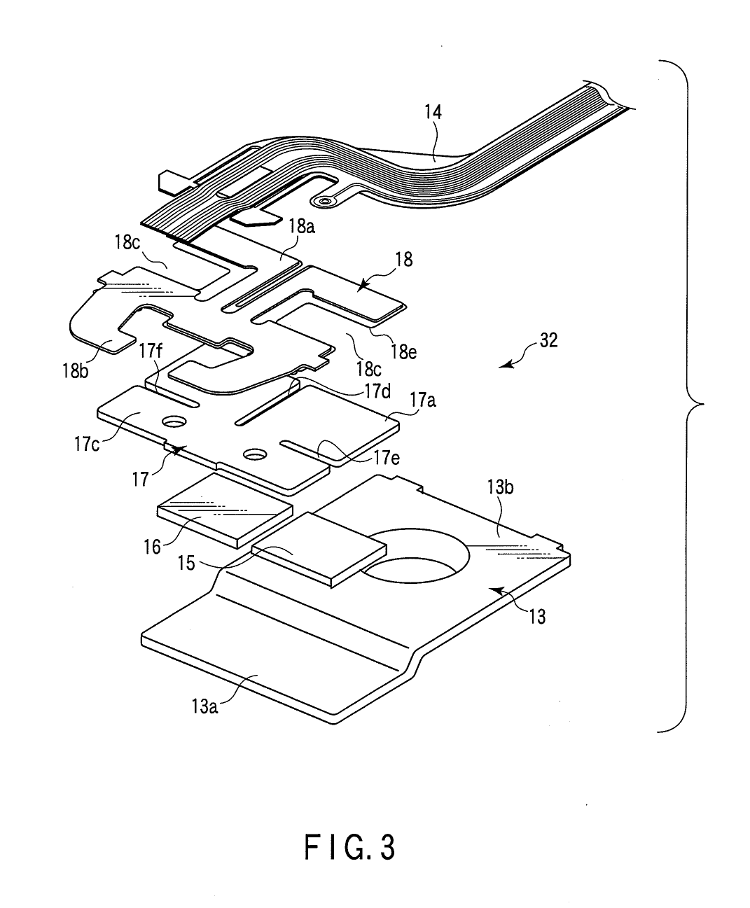

As shown in FIGS. 3, 4, 5A and 5B, an insulating layer (first insulating layer) 18e is bonded to the joint surface of the support plate 18 that faces the hinge plate 17 so as to cover the hinge plate junction 18a. The insulating layer 18e may be formed of, for example, polyimide and serves to electrically insulate the hinge plate 17, to which the driving potentials of the piezoelectric elements are applied, from the load beam 12 at the ground potential.

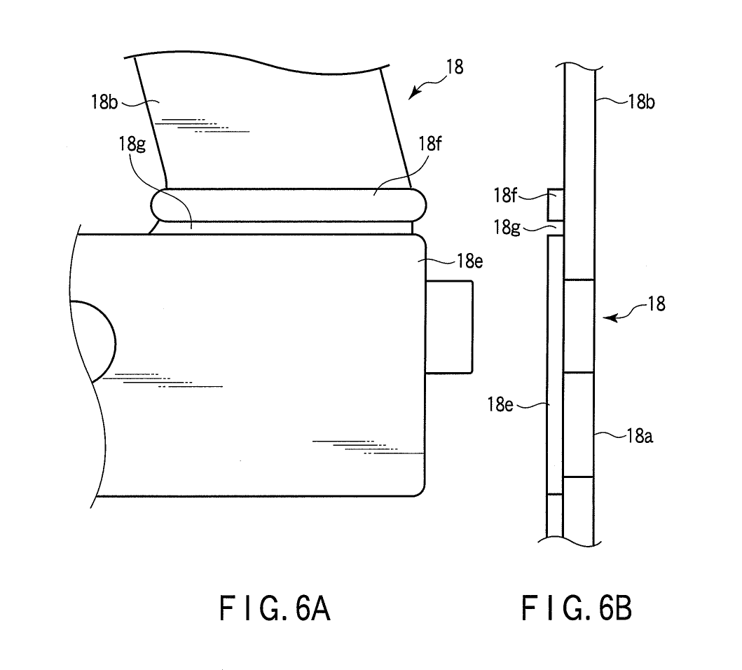

The insulating layer 18e has an external shape slightly larger than that of the hinge plate junction 18a of the support plate 18. Those parts of the insulating layer 18e which overlap the notches 18c are notched to be shaped to the notches 18c. As shown in FIG. 5B, the insulating layer 18e is bonded to the entire surface of the hinge plate junction 18a of the support plate 18. Tape-like insulating layers (second insulating layers) 18f are bonded individually to proximal parts of the load beam junction 18b that extends from the hinge plate junction 18a. These insulating layers 18f are spaced apart from the insulating layer 18e. Thus, a control groove 18g is defined between the insulating layer 18e and each insulating layer 18f, as shown in FIGS. 6A and 6B. In other words, the control grooves 18g without insulating layers are disposed at the boundary between the load beam junction 18b and hinge plate junction 18a.

The control grooves 18g serve to receive the adhesive that overflows from an edge of the insulating layer 18e toward the load beam junction 18b. Thus, in bonding the insulating layer 18e to the support plate 18, the adhesive running out of the insulating layer 18e, which has a large bonding area, can be stemmed by the tape-like insulating layers 18f with the aid of the control grooves 18g. Accordingly, the adhesive having run out of the insulating layer 18e cannot overflow toward the load beam junction 18b, so that the mass balance of the load beam 12 can be prevented from being broken by the overflowed adhesive. Further, variations of mechanical properties, such as spring load, pitch, and roll properties, of the head suspension assembly 24 can be controlled.

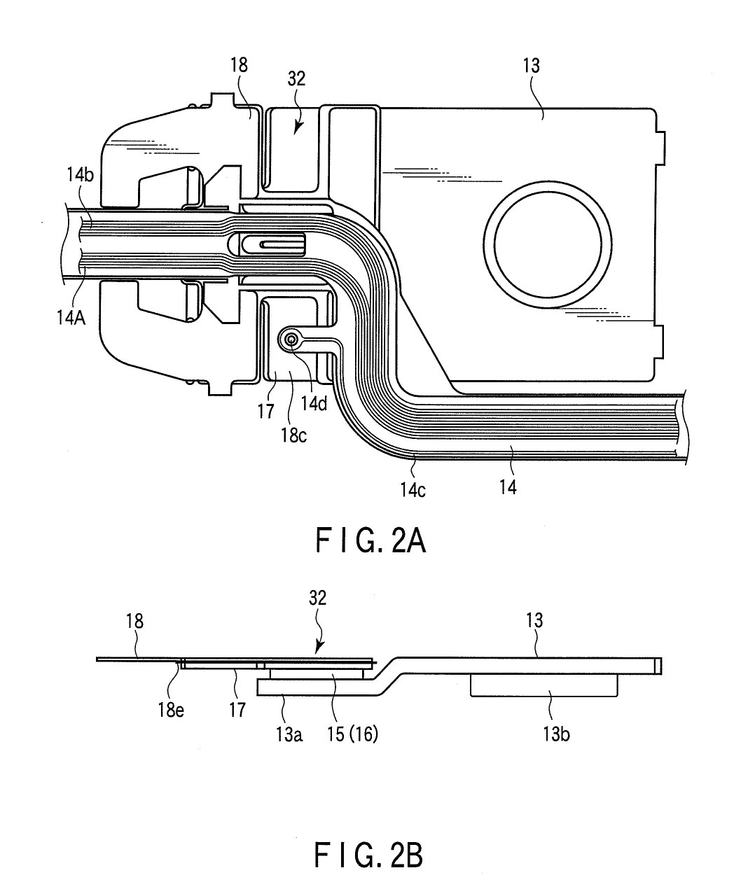

After the microactuator 32 is constructed by laminating the piezoelectric elements 15 and 16, hinge plate 17, and support plate 18 on the baseplate 13, as shown in FIGS. 1, 2A and 2B, the elements 15 and 16 are electrically connected to each other. The electrical connection of the elements 15 and 16 is achieved by connecting the hinge plate 17 as a movable electrode to the suspension flexure 14. The flexure 14 is formed by depositing copper conductors on, for example, a stainless-steel plate with an insulating layer of polyimide therebetween. The flexure 14 is located on the load beam 12 and microactuator 32, and its distal end is electrically connected to the magnetic head 30. The other end of the flexure 14 is connected to the main board.

The conductors on the suspension flexure 14 comprise signal lines 14a and 14b for writing and reading data to and from the magnetic head 30 and an actuator driving signal line 14c for supplying a driving signal to the microactuator 32. A trailing end portion 14d of the signal line 14c is formed so as to be located within one of the notches 18c when the suspension flexure 14 is located on the head suspension, as shown in FIG. 2A. The trailing end portion 14d of the signal line 14c is electrically connected directly to the hinge plate 17 through the notch 18c. This electrical connection is made by using an electrically conductive adhesive, such as silver paste.

The head suspension assembly 24 constructed in this manner is pivotable around a boss portion 13b of the baseplate 13, which is fixed to the carriage arm of the magnetic disk drive. In the microactuator 32, an actuator driving signal is applied to the piezoelectric elements 15 and 16, which are oppositely polarized and arranged side by side, through the baseplate 13 and hinge plate 17. As the actuator driving signal is applied in this manner, the piezoelectric elements 15 and 16 are displaced in their respective shear directions with respect to the baseplate 13. Thus, the elements 15 and 16 transmit their respective shear displacements to the load beam 12 through the hinge plate 17 and support plate 18, thereby causing the head suspension to swing. This slight swinging motion of the microactuator 32 is amplified on the distal end side of the load beam 12 on which the head slider 11 is mounted, thereby causing the slider to swing wide.

When the magnetic disk drive constructed in this manner is in operation, the head suspension assembly 24 pivots around the shaft 23, whereupon the magnetic head 30 is moved to and positioned in a region above a desired recording track of the magnetic disk 22. The head 30 scans the disk 22 from above, thereby writing and reading data to and from the disk 22. In positioning the head 30 above the desired recording track of the disk 22 by pivoting the head suspension assembly 24, the head 30 can be positioned more quickly and accurately with respect to the recording track by being swung by the microactuator 32.

In the microactuator 32, one of the electrodes is formed of the conductive hinge plate 17 without using any independent electrode plate, the other electrode is formed of the conductive baseplate 13, and an actuator driving voltage is applied directly from the suspension flexure 14 to the hinge plate 17. Thus, the microactuator can be constructed using fewer components and the number of man-hours for assembly can be reduced, so that the manufacturing cost can be considerably reduced.

While certain embodiments of the invention have been described, these embodiments have been presented by way of example only, and are not intended to limit the scope of the invention. Indeed, the novel methods and systems described herein may be embodied in a variety of other forms. Furthermore, various omissions, substitutions and changes in the form of the methods and systems described herein may be made without departing from the spirit of the invention. The accompanying claims and their equivalents are intended to cover such forms or modifications as would fall within the scope and spirit of the invention.

What is claimed is:

1. A head suspension assembly comprising:
a load beam supporting a head; and
a microactuator configured to swing the load beam,
the microactuator comprising two piezoelectric elements configured to shear when the two piezoelectric elements are aligned next to each other and configured to receive a voltage in such a manner that directions of shearing of the two piezoelectric elements are opposite, a first electrode and a second electrode configured to hold the piezoelectric elements therebetween, and a supporting plate attached to the first electrode with an insulating layer therebetween, attached to the load beam and configured to support the load beam.

2. The head suspension assembly of claim 1, wherein the support plate comprises an electrode junction connected to the first electrode with the insulating layer therebetween and a load beam junction connected to the load beam, and a control groove is at a boundary between the load beam junction and the electrode junction.

3. The head suspension assembly of claim 2, wherein the insulating layer comprises a first insulating layer connected to the electrode junction of the supporting plate and configured to cover the electrode junction and a second insulating layer apart from the first insulating layer and connected to the load beam, and the control groove is defined by a gap between the first and second insulating layers.

4. The head suspension assembly of claim 3, wherein the first and second insulating layers comprise polyimide.

5. The head suspension assembly of claim 1, wherein the supporting plate comprises a notch or an opening by removing a portion of a region of the supporting place attached to the first electrode with the insulating layer therebetween, and a flexure on a side of the support plate opposite to the insulating layer and comprising a signal line electrically connected to the first electrode through the notch or the opening.

6. The head suspension assembly of claim 1, wherein the first electrode comprises an electrically conductive hinge plate comprising first and second attaching surfaces configured to attach the two piezoelectric elements respectively, a third surface comprising a gap from the piezoelectric elements, and slits configured to partially divide the first and second attaching surfaces and the third surface.

7. The head suspension assembly of claim 1, wherein the second electrode comprises an electrically conductive baseplate configured to pivotably support the microactuator and the load beam.

8. A magnetic disk drive comprising:
a head configured to read information from a disk recording medium and to write information to the disk recording medium; and
a rotatable head suspension assembly configured to support the head,
wherein the head suspension assembly comprises a load beam configured to support the head and a microactuator configured to swing the load beam, and
wherein the microactuator comprises two piezoelectric elements configured to shear when the two piezoelectric elements are aligned next to each other and configured to receive a voltage in such a manner that directions of shearing of the two piezoelectric elements are opposite, a first electrode and a second electrode configured to hold the piezoelectric elements therebetween, and a supporting plate attached to the first electrode with an insulating layer therebetween, attached to the load beam and configured to support the load beam.
